(19) United States
(12) Patent Application Publication
(10) Pub. No.: US 2007/0234383 A1
(43) Pub. Date: Oct. 4, 2007

(54) METHOD FOR COMMUNICATING INFRARED REMOTE CONTROL DATA AND LEARNING INFRARED REMOTE CONTROL DEVICE

(75) Inventor: Kenichi Miwa, Shinagawa-ku (JP)

Correspondence Address: DARBY & DARBY P.C., P.O. BOX 770, Church Street Station, New York, NY, 10008-0770, US

(73) Assignee: SMK CORPORATION, Tokyo (JP)

(21) Appl. No.: 11/462,891

(22) Filed: Aug. 7, 2006

(30) Foreign Application Priority Data
Dec. 20, 2005 (JP) 2005-367059

(51) Int. Cl. H04N 5/445

(52) U.S. Cl. 725/37

(57) ABSTRACT

In an infrared remote control device, communication between a host CPU and an infrared controller is compressed by encoding the signal into pulse data (“PD”) number or sequence data that corresponds to each pulse data type. Encoding and decoding is performed by table look ups that associate the pulse data types with the PD numbers. Because conventional infrared control devices represent each infrared pulse as a four byte digital number, when the PD number is represented by 4 bits, a maximum of 16 types of pulse data can be stored in the data, making it possible to compress the communication data volume to ⅛ as compared to the uncompressed data volume.

### CROSS-REFERENCE TO RELATED APPLICATION

The present application claims priority under 35 U.S.C. §119 to Japanese Patent Application No. 2005-367059 filed on Dec. 20, 2005. The content of Japanese Patent Application No. 2005-367059 is incorporated herein by reference in its entirety.

### FIELD OF THE INVENTION

The present invention relates to a learning-type (intelligent) infra-red remote control device used to remotely operate or control household appliances and the like using a personal computer. The present invention also relates to a device for connecting through USB communications an infrared control device that sends and receives infrared light and a host such as a personal computer.

### BACKGROUND OF THE INVENTION

Examples of infrared signals used in infrared remote control devices in electric home appliances include the signal format of the Kaden Seihin Kyoukai (the Association for Electric Home Appliances) (the Kadenkyo format) and manufacturers' formats that provide extensions and modifications of the same. In both of these, the basic structure of the signal, shown in FIG. 4, is formed from: a header (a) indicating the start of a transmission signal+a custom code (b) indicating the control (instruction) type+a data code (c) indicating the contents of the control+an end bit (d) indicating the end of the transmission signal; a repeat header (e); and a repeat end bit (f).

Next, the signal will be described in more detail using an example of a manufacturer format.

In the above description, the time interval for one entire pulse from the leading edge (on) to the trailing edge (off) of a pulse and then to the leading edge of the next pulse is referred to as the pulse width. The time from the leading edge (on) to the trailing edge (off) of the pulse is referred to as the mark width.

The header (a) has a mark width of 9 ms and a pulse width of 13.5 ms. The custom code (b) and the data code (c) are formed from a combination of sixteen “0”s, which have a mark width of 0.56 ms and a pulse width of 1.125 ms, and “1”s, which have a mark width of 0.56 ms and a pulse width of 2.25 ms. The end bit (d) has a mark width of 0.56 ms and a pulse width of 40.5 ms. The repeat header (e) has a mark width of 9 ms and a pulse width of 11.25 ms. The repeat end bit (f) has a mark width of 0.56 ms and a pulse width of 96.75 ms.

In the Kadenkyo format, there is in some cases a 4-bit parity check value after the custom code (b) for verifying the custom code (b).

Since conventional infrared control devices that receive infrared signals process the signal waveform directly as digital data, 4 bytes are needed to represent each pulse. Thus, representing one complete set in an infrared signal requires, at a minimum, 1 pulse for the header (a), 8×2=16 pulses for the custom code (b), 8×2=16 pulses for the data code (c), and 1 pulse for the end bit (d), i.e., 34 pulses×4 bytes=136 bytes.

With the rapid development of personal computers that is taking place, increasing performance and diminishing prices are resulting in a diversification of usage, turning the personal computer into a home appliance in regular households. One aspect of this diversified usage includes a linkage of personal computers with home appliances such as AV (audio visual) devices. With AV devices, as digital video and audio becomes more standard, the trend is beyond simple linkage toward the appearance in the marketplace of personal computers integrated with AV devices and OSs (operating systems) that are built for integration with AV devices.

To achieve these types of linkage or integration of personal computers and home appliances, an infrared communication device and a personal computer (host CPU) must be connected with communicating means. U.S. Patent Application Publication No. 2002/0129289, published on Sep. 12, 2002, discloses a personal computer having an embedded controller—keyboard controller (ECKBC) that is interconnected with a CPU via a peripheral component interconnect (PCI) bus and associated bridge, and also to an infrared controller. The CPU is able to access the infrared controller, which thereby is able to operate as a receiver for remote control of the personal computer. Publication No. 2002/0129289 was also published on Apr. 5, 2002 as Japanese Patent Publication No. 2002-101476, and is hereby incorporated by reference herein in its entirety.

USB (Universal Serial Bus) communications is growing in popularity as a communication method between personal computers and peripherals or home appliances. In particular, USB communication is becoming the primary method for communicating with home appliances, with these appliances being referred to sometimes as USB devices. Infrared communication devices are also part of this trend, with USB communication being used frequently with the host CPU, e.g., a personal computer.

As the name indicates, in USB communication the transmission and reception of signals takes place serially. While this reduces the requirements for numbers of signal lines, the method is not suited for high-speed data communication. Shortly after implementation (USB Ver. 1.1), two types of USB were available: 1.5 Mbps (low-speed) and 12 Mbps (full-speed). For storage devices, e.g., hard drives, that send and receive large amounts of data, even full-speed USB was inadequate. To address this limitation, subsequent standards (USB Ver. 2.0) have been developed and implemented for 480 Mbps (high-speed) communications.

Using the flowchart shown in FIG. 5, the “learning” performed by an infrared control device will be described. A related method for leaning by an infrared control device is described, for example, in Japanese Patent Publication No. 2003-051962, published on Feb. 21, 2003.

As illustrated in FIG. 5 of the present application, when learning is started (step F1), a learning circuit initializes memory and the like as necessary (step F2). An infrared signal to be learned for the purpose of sampling is transmitted in the direction of an infrared receiver, and the signal received by the receiver is converted to an electrical signal that is sent to the learning circuit. The learning circuit performs the following operations to learn the signal.

After entering a main learning loop (step F4), a determination is made as to whether sampling has been completed or not (step F4), and if sampling has been completed, the signal data stored in a USB buffer is sent to a host CPU by way of a USB interface (step F15), and the operation is completed (step F11).

If sampling has not been completed, a determination is made as to whether a signal has been received or not (step F5). If there is no input signal, the sampling completion evaluation (step F4) is performed again. If an input signal is present, a mark width, a pulse width, and a carrier count are stored in the USB output buffer (step F14).

The USB buffer is checked to see if the packet data has filled the buffer (step F9). If the buffer is full, the signal data stored in the USB buffer is sent to the host CPU by way of the USB interface (step F16). Then, control returns to the main learning loop (step F3) to process the next signal.

With the infrared signal format described above, if the infrared communication device and the host CPU are connected using USB communication, Ver. 1.1 low-speed communication is inadequate and full-speed communication is required.

With communications in general (not just USB communications), higher communications speeds will lead to higher requirements in parts performance and speed as well as a greater number of parts in the communication interface, thus resulting in a more expensive interface. In the case of USB interfaces, the UART (Universal Asynchronous Receiver Transmitter) must be high-speed, and requires a larger buffer to prevent over-runs.

If a personal computer currently on the market is to be used as a host CPU, a Ver.2.0-compatible USB interface is generally provided as a standard feature for connecting to other peripherals. Thus, there are no special problems on the host CPU side. However, while the infrared control device does not require installation of a high-speed USB interface, USB Ver.1.1 full-speed compatible interface will be required just to transfer data from the infrared remote control device.

In some cases, an expensive RISC (Reduced Instruction Set Computer) with an internal USB interface that performs full-speed USB communication may be installed.

### SUMMARY OF THE INVENTION

In the present invention, an infrared remote control device is equipped with an infrared receiver receiving an infrared signal from an infrared transmitter and converting the signal to an electric signal, and an infrared control device controlling a home appliance based on the signal from the infrared receiver or sending the signal to a host CPU to store the signal. Communication between the host CPU and the infrared control device is performed with compression by encoding the signal into PD number data (sequence data) corresponding to each pulse data in the signal.

When PD numbers are represented by 4 bits, for example, a 34 pulse×4 byte=136 byte signal can be compressed to 34 pulses×4 bits=136 bits=17 bytes. Thus, the volume of data communicated between the infrared control device and the host CPU can be compressed to ⅛.

Encoding for data compression is performed by a “look-up” in a table that associates pulse data with PD numbers. For example, a single PD number may be represented by 4 bits, in a table containing up to 16 types of pulse data. In this manner, all pulse data used in standard infrared remote control devices can be stored, and the data can be compressed sufficiently to allow communication to take place adequately using USB Ver.1.1 low-speed communication.

### BRIEF DESCRIPTION OF THE DRAWINGS

The invention will become more readily apparent from the Detailed Description of the Invention, which proceeds with reference to the drawings, in which:

FIG. 1 is a block diagram illustrating a learning infrared remote control device according to the present invention;

FIG. 2 is a flowchart showing the learning operation performed by a learning infrared remote control device according to the present invention;

FIG. 3 is a drawing showing the contents of a table used to encode a remote control signal into sequence data;

FIG. 4 is a waveform diagram showing an example of a manufacturer format for a remote control signal; and

FIG. 5 is a flowchart showing the learning operation performed by a conventional learning infrared remote control device.

### DETAILED DESCRIPTION OF THE INVENTION

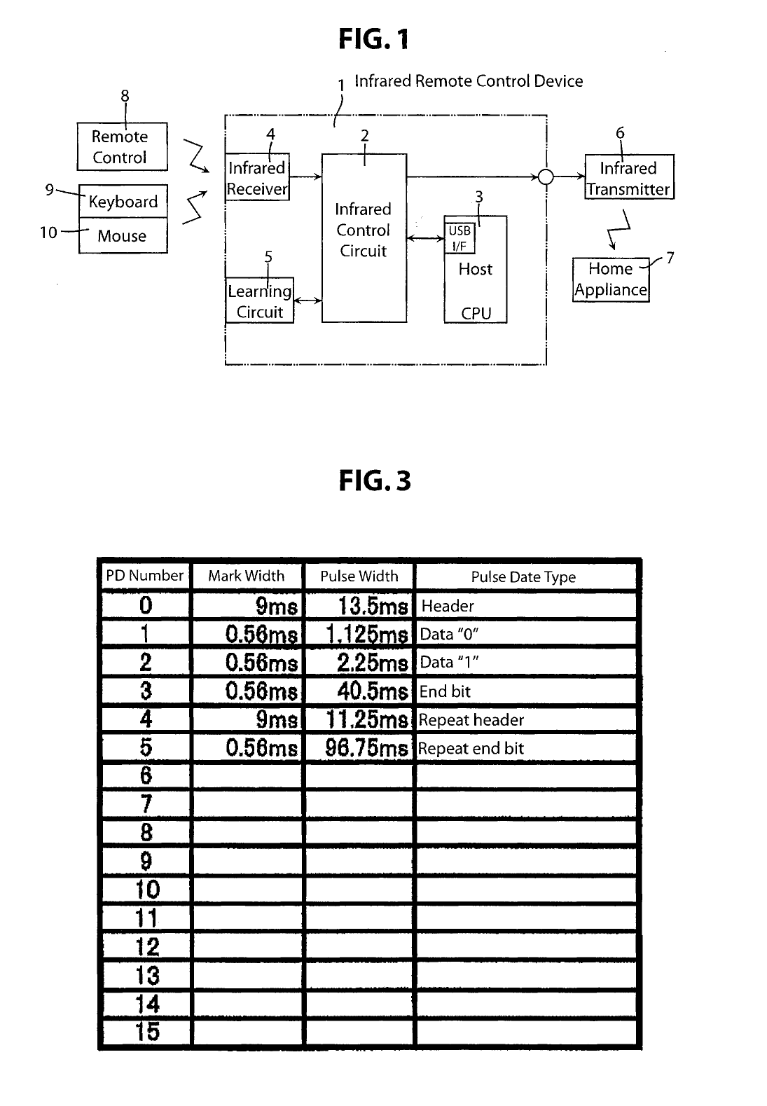

Referring to FIG. 1 through FIG. 3, an embodiment according to the present invention of a learning infrared remote control device will be described. In this embodiment, a personal computer is used to operate/control a home appliance. Input devices such as a keyboard and mouse are also connected through infrared communication.

FIG. 1 shows the infrared remote control device 1, including an infrared control circuit 2 and a host CPU (personal computer) 3. The infrared control circuit 2 is connected to an infrared receiver 4, a learning circuit 5, and an infrared transmitter LED 6. The infrared control circuit 2 is also connected to the host CPU 3 by way of a USB Ver.1.1 low-speed compatible interface.

When a personal computer is used as in this embodiment, the infrared control circuit 2, the infrared receiver 4, and the learning circuit 5 may be installed for example in the case of the host CPU 3. The infrared transmitter LED 6 is generally set up outside the case of the host CPU 3 since it must be installed in an appropriate position facing a target home appliance 7.

A remote control 8, a keyboard 9, and a mouse 10 communicate with the infrared control circuit 2 by way of the infrared receiver 4.

The infrared control circuit 2 is equipped with an internal table 11, in which a PD number is assigned to each type of pulse data. In this table 11, pulse data representing infrared signal waveforms can be assigned to PD numbers, e.g., the 16 numbers 0-15 represented by 4 bits.

For example, as shown in FIG. 3, the header is assigned to PD number 0, “0”s in the custom code and the data code are assigned PD number 1, “1”s in the custom code and the data code are assigned PD number 2, the end bit is assigned PD number 3, the repeat header is assigned PD number 4, and the repeat end bit is assigned PD number 5.

In this structure, the infrared signal received by the infrared receiver 4 from the remote control 8 is converted to a corresponding electric signal and sent to the infrared control circuit 2. The infrared control circuit 2 analyzes the transferred signal and, based on the results of this analysis, outputs (communicates) associated signals to the CPU 3 and to the external home appliance 7 by way of the infrared transmitter LED 6 and the like.

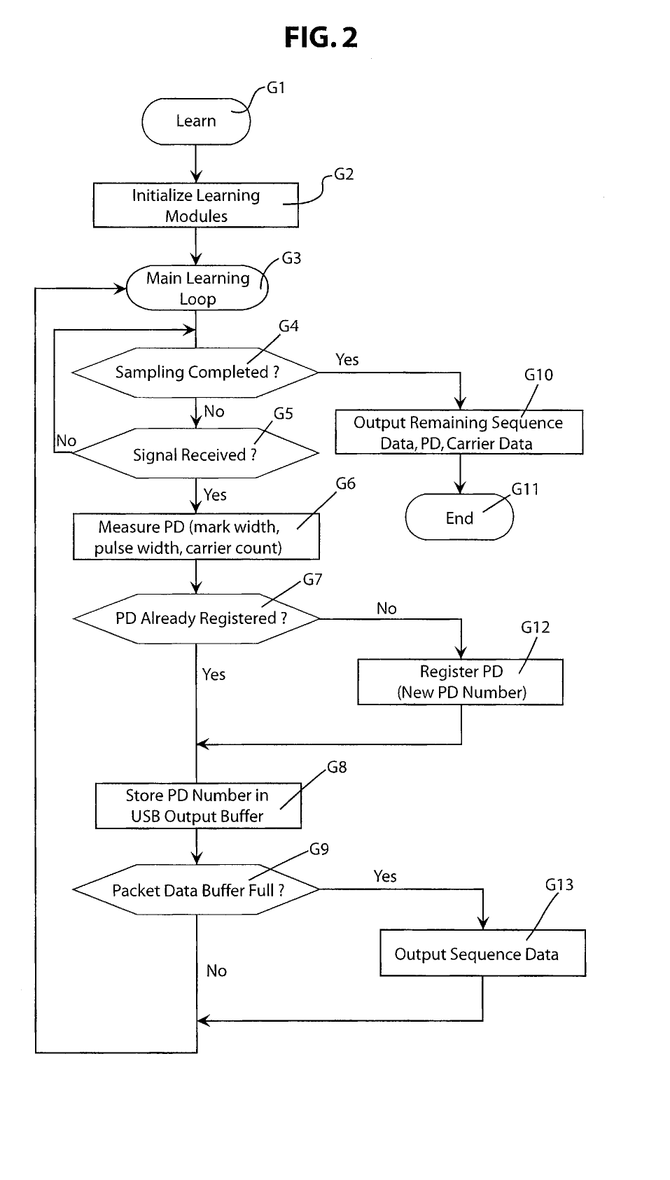

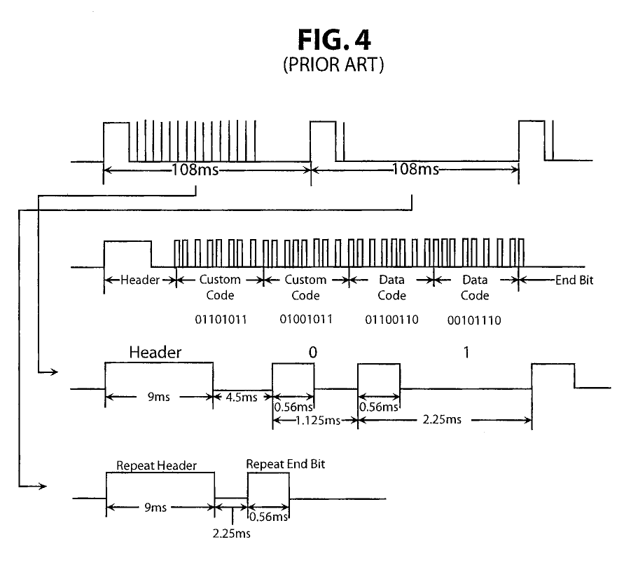

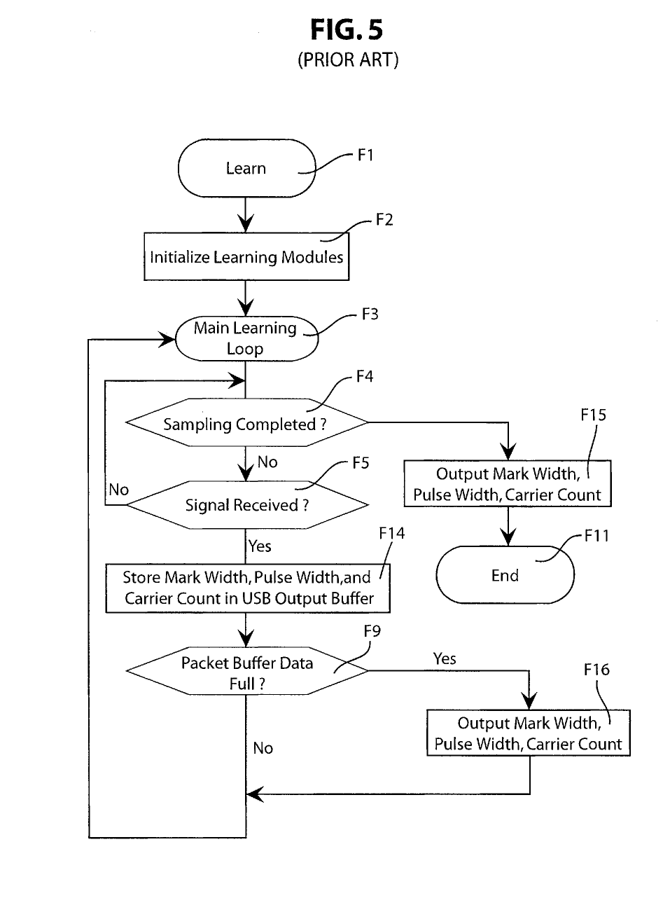

Next, the learning operation performed by the infrared control device described above will be described with reference to the flowchart in FIG. 2.

When learning is started (step G1), the learning circuit 5 performs initialization needed for the learning operation of the memory and the like (step G2). When an infrared signal to be learned is sent toward the infrared receiver for sampling, the receiver converts the received signal to an electrical signal and sends it via the infrared control circuit 2 to the learning circuit 5. The learning circuit 5 performs the following operations to learn the sampled signal.

First, a determination is made as to whether sampling has been completed or not (step G4), and if sampling has been completed the sequence data (PD number series) stored in a USB buffer is sent to a host CPU 3 by way of the infrared control circuit 2 and a USB interface of the host CPU 3 (step G10), and the operation is completed (step G11). The host CPU 3 stores this data.

If sampling has not been completed, a determination is made as to whether a signal has been received or not (step G5). If there is no input signal, the sampling completion evaluation (step G4) is performed again. If an input signal is present, the pulse data (the mark width, the pulse width, and the carrier count) are measured (step G6).

An evaluation is performed to see whether the pulse data has already been registered (step G7). If it has not been registered, an available PD number is assigned to the measured pulse data and the information is entered in the table 11. The PD number corresponding to the pulse data is stored in the USB output buffer (step G8).

The USB buffer is checked to see if the packet data has filled the buffer (step G9). If the buffer is full, the signal data stored in the USB buffer is sent to the host CPU 3 by way of the USB interface (step G13), and the host CPU 3 stores this data. Then, control returns to the main learning loop (step G3) to process the next signal.

The sequence data output by the learning circuit 5 to the infrared control device 2 for the host CPU 3 to store is encoded by look up in the table 11. For example, in the case of header+“01101011” (custom code)+“01001011” (custom code)+“01100110” (data code)+“00101110” (data code)+end bit, the encoded result output to the host CPU 3 would be “0 12212122 12112122 12211221 11212221 3”. (The spaces are inserted simply to delimit the header, the custom codes, the data codes, and the end bit. They would not be used in practice.)

Also, when data is to be read from the host CPU 3 to the infrared control device 1, the sequence data stored in the host CPU 3 is read directly in its compressed form and then decoded into the original signal by looking up the table 11.

As described above, by performing communication between the infrared control device 1 and the host CPU 3 using sequence data in which individual pulse data is encoded into PD numbers, the volume of data communicated can be significantly reduced so that USB Ver.1.1 low-speed communication can be used. Thus, the cost of the USB interface can be reduced.

As described with regard to the background technology, there are generally 6 basic infrared remote control pulse types. Even if the number of types is increased due to extensions, 16 types, which can be expressed as 4 bits, will be adequate. If there is a possibility that 16 types will not be enough, 32 types can be made available by using 5 bits. In this case, 34 pulses can be expressed in 22 bytes.

Numerous details have been set forth in this description, which is to be taken as a whole, to provide a more thorough understanding of the invention. In other instances, well-known features have not been described in detail, so as to not obscure unnecessarily the invention.

The invention includes combinations and subcombinations of the various elements, features, functions and/or properties disclosed herein. The following claims define certain combinations and subcombinations, which are regarded as novel and non-obvious. Additional claims for other combinations and subcombinations of features, functions, elements and/or properties may be presented in this or a related application.

What is claimed is:

1. In an infrared remote control device equipped with: an infrared receiver receiving an infrared signal from an infrared transmitter and converting said signal to an electric signal; and an infrared control device controlling a home appliance based on said signal from said infrared receiver or sending said signal to a host CPU to store said signal,
a method for communicating infrared remote control data wherein communication between said host CPU and said infrared control device is performed with compression by encoding said infrared signal into pulse data (PD) number data, wherein each PD number corresponds to one type of pulse data in said signal.

2. The method for communicating infrared remote control data according to claim 1, wherein said encoding step includes a table look-up step that associates pulse data with PD numbers.

3. The method for communicating infrared remote control data according to claim 2. wherein said table stores a maximum of 16 types of pulse data and each PD number is represented by 4 bits.

4. The method for communicating infrared remote control data according to claim 1, wherein the infrared control device transmits said signal to the host CPU over a low-speed serial communications bus

5. The method for communicating infrared remote control data according to claim 4, wherein the low-speed serial communications bus is a universal serial bus (USB).

6. The method for communicating infrared remote control data according to claim 3, wherein each infrared pulse is represented by 4 bytes, the PD number is represented by 4 bits, and the volume of encoded communication data to un-encoded communication is ⅛.

7. In an infrared remote control device equipped with: an infrared receiver receiving an infrared signal from an infrared transmitter and converting said signal to an electric signal; and an infrared control device controlling a home appliance based on said signal from said infrared receiver or sending said signal to a host CPU to store said signal, the infrared control device comprising:
a learning circuit for building a look-up table for associating pulse data (“PD”) numbers with a plurality of types of infrared pulse data;
means for compressively encoding said received signal into sequence data represented by PD numbers by referencing the look-up table; and
a low-speed communication interface for transmitting the encoded sequence data to the host CPU.

8. The infrared remote control device according to claim 7, wherein the low speed communication interface is a universal serial bus (“USB”) interface.

9. The infrared remote control device according to claim 7, wherein the look-up table stores a maximum of 16 types of pulse data, and each PD number is represented by 4 bits.

10. The infrared remote control device according to claim 7, wherein each infrared pulse is represented by 4 bytes, the PD number is represented by 4 bits, and the volume of encoded communication data to un-encoded communication is ⅛.
